(19) United States
(12) Patent Application Publication
(10) Pub. No.: US 2013/0192887 A1
(43) Pub. Date: Aug. 1, 2013

(54) FLAT WIRING MATERIAL AND MOUNTING BODY USING THE SAME

(71) Applicant: Hitachi Cable, Ltd., Tokyo (JP)

(72) Inventors: Akihiro YAGUCHI, Kasama (JP); Takumi KOBAYASHI, Hitachi (JP); Yuju ENDO, Hitachi (JP); Hiroaki KOMATSU, Hitachi (JP); Kenichi MURAKAMI, Hitachi (JP); Rikio SAITO, Kitaibaraki (JP)

(73) Assignee: HITACHI CABLE, LTD., Tokyo (JP)

(21) Appl. No.: 13/713,739

(22) Filed: Dec. 13, 2012

(30) Foreign Application Priority Data
Jan. 27, 2012 (JP) 2012-015304

(51) Int. Cl. H01B 7/08

(52) U.S. Cl. CPC H01B 7/0823; H01B 7/0846
USPC 174/262; 174/117 FF

(57) ABSTRACT

A flat wiring material includes a plurality of conductors arranged in parallel, an insulating covering member covering collectively the plurality of conductors while allowing both end portions of the plurality of conductors to be exposed, an engaging member disposed at a position on the covering member and close to at least one of the exposed both end portions of the plurality of conductors and including an insertion portion that is formed at an end portion extending in the width direction for being inserted into and engaged with a through-hole formed on a mounting substrate, and a fixing member fixing the engaging member to the covering member. The insertion portion of the engaging member includes an opening allowing an elastic deformation thereof upon the insertion into the through-hole and a protruding portion for preventing disengagement in a direction opposite to the insertion direction after being inserted into the through-hole.

The present application is based on Japanese patent application No. 2012-015304 filed on Jan. 27, 2012, the entire contents of which are incorporated herein by reference.

### BACKGROUND OF THE INVENTION

1. Field of the Invention

The invention relates to a flat wiring material such as a flexible flat cable, an MFJ (Multi Frame Joiner) and a flexible printed circuit board and to a mounting body using the flat wiring material.

2. Description of the Related Art

Conventionally, wire harnesses are used as a wiring component for electrical connection between plural printed circuit boards which are mounted on an on-board inverter unit or engine-control unit. In addition, a connection structure using a connector assembly is adapted for electrically connecting the wire harness to the printed circuit boards. In recent years, as a measure to realize downsizing, weight reduction and cost reduction of the above-mentioned on-board equipments, use of wiring component as a substitute for the wire harness and simplification of connection process are required.

On the other hand, the on-board equipments have been also required to have high reliability on durability in long-term use. It is essential also for wiring components mounted on the on-board equipments or a connecting portion thereof to ensure reliability against long-term vibration load or thermal load.

In the wiring component connecting the plural printed circuit boards which are mounted inside the equipments, resonant vibration could occur in the wiring component in response to vibration load applied to the on-board equipment. The resonant vibration could apply a relatively large repeated mechanical load to the connecting portion of the wiring component. The mechanical load may impair electrical connection at the connecting portion of the wiring component or may destroy a conductor portion constituting the wiring component or a connecting portion thereof. For such reasons, it is important for the wiring component used in the on-board equipments to ensure reliability especially against mechanical load applied due to vibration.

In order to meet the above-mentioned requirements of downsizing, weight reduction and cost reduction of the on-board equipments, an inter-substrate connection structure using so-called flexible flat cable as a wiring component inside an on-board equipment is proposed. In the flexible flat cable, plural conductors (consisting mainly of copper such as oxygen-free copper or tough-pitch copper) which are arranged in parallel in a width direction and are covered with a covering insulating film from both sides in a thickness direction of the conductor are integrated by adhesion using an adhesive (see, e.g., Patent Literature 5). In this flexible flat cable, a conductor exposed portion in which the conductor is exposed from the insulating film is formed at both longitudinal end portions of the conductor, and the flexible flat cable is electrically connected to a printed circuit board at the conductor exposed portion. Note that, in addition to the flexible flat cables, MIJs (Multi Frame Joiner) having a similar structure to the flexible flat cable and flexible printed circuit (FPC) boards, etc., are also employed for a flat wiring material used as a wiring component inside on-board equipments. All of these have a structure in which plural conductors are arranged in parallel in a width direction to form a flat wiring material even though a manufacturing method and a constituent material of the flat wiring material are different. Hereinafter, the flexible flat cable will be explained as a typical example of the flat wiring material.

There is a case that an insulation displacement connector is used for electrically connecting the flexible flat cable to the printed circuit board. For electrical conduction, the conductor exposed portion at a terminal end portion of the flexible flat cable is inserted into an opening of the connector and the conductor of the flexible flat cable is pressure-welded to an electrode of the connector. In the connection using the connector, the flexible flat cable is also mechanically fixed by insertion thereof into the opening of the connector.

Connection of the flexible flat cable through the connector is advantageous in that it is easy to insert and remove the flexible flat cable. However, in the on-board equipment required to be downsized and to reduce weight, it may not be possible to make room for placing the connector on the printed circuit board due to design problems.

Meanwhile, in the connection using the insulation displacement connector, a problem of connection reliability arises since connection failure called instantaneous interruption, which is a temporary interruption of contact between the conductor exposed portion of the flexible flat cable and the electrode of the connector caused by vibration load, may occur.

For electrically connecting the conductor exposed portion of the flexible flat cable to an electrode portion provided on the printed circuit board, direct connection by a bonding material such as solder material or conductive adhesive without using the connector is sometimes adapted. By directly connecting the conductor exposed portion using the solder material, etc., it is possible to cope with downsizing due to reduction of a connecting portion area and to reduce the number of connection parts. In addition, it is possible to obtain effects such as reduction of mounting steps or simplification of process since solder connection to electronic components, other than wiring components, to be mounted on the printed circuit board is carried out at the same time. In addition, since connection using a bonding material such as solder material or resin with conductive metal particles is generally the metal joining by formation of intermetallic compound, instantaneous interruption does not occur at an electrical contact point unlike in the insulation displacement connector and electrically stable bonding is obtained.

For directly connecting the conductor exposed portion of the flexible flat cable to the corresponding electrode portion of the printed circuit board by a solder material, there is a case that the solder material pre-coated and solidified on the electrode of the printed circuit board is remelted and re-solidified to carry out the connection. This is because, when the flexible flat cable is attached to the printed circuit board during assembling/installing processes of a device, it may be difficult to supply a paste solder material due to restriction of assembly work.

A specific connection method in which the solder material is remelted and re-solidified includes overall or local heating by a reflow furnace, thermocompression bonding using, e.g., a small heating tool (see, e.g., Patent Literature 1) or heating by infrared ray, etc.

In solder connection of the conductor exposed portion of the flexible flat cable which is carried out in a state that the solder material in the form of solidified or non-solidified paste is pre-coated on the electrode of the printed circuit board, it is necessary to align the position of the conductor exposed portion of the flexible flat cable with the position of the corresponding electrode of the printed circuit board and to maintain the contact state or the state of being close enough to substantially contact with each other. For example, in Patent Literature 5, it is described that the conductor exposed portions of the flexible flat cable are temporarily fixed in a state of being respectively positioned on the corresponding electrode portions on the printed circuit board and the solder material is melted by the above-mentioned heating means and is solidified for the connection.

### Patent Literatures

The following patent literatures may be the related art to the invention.

Patent Literature 1: JP-A-2009-32764

Patent Literature 2: JP-A-2001-93344

Patent Literature 3: JP-A-2006-156079

Patent Literature 4: JP-A-2003-264019

Patent Literature 5: JP-A-10-41599

### SUMMARY OF THE INVENTION

According to the method of connecting the flexible printed circuit board to the flexible flat cable described in Patent Literature 5, side-slip at the time of connection can be prevented by inserting and temporarily fixing the conductor exposed portions of the flexible flat cable into/to grooves provided on the flexible printed circuit board when carrying out solder connection. However, since suppression of mechanical load applied to a connecting portion due to vibration, etc., in case of using the flexible flat cable as a wiring component for on-board equipment is not taken into consideration at all, large repeated mechanical load applied to the connecting point may impair electrical connection at the connecting portion or may destroy the connecting portion or the conductor exposed portions. That is, there is a problem that stable and highly reliable connection of the connecting portion is not ensured.

Accordingly, it is an object of the invention to provide a flat wiring material that allows stable and highly reliable solder connection between an exposed portions of a conductor and an electrode portion of a mounting substrate even when the exposed portion of the conductor of the flat wiring material such as a flexible flat cable, an MFJ and a flexible printed circuit board is directly connected by a solder to the electrode portion of the mounting substrate pre-coated with the solder, as well as a mounting body using the flat wiring material.

(1) According to one embodiment of the invention, a flat wiring material comprises:

a plurality of conductors arranged in parallel at intervals in a width direction;

an insulating covering member covering collectively the plurality of conductors while allowing both end portions of the plurality of conductors to be exposed;

an engaging member disposed at a position on the covering member and close to at least one of the exposed both end portions of the plurality of conductors and comprising an insertion portion that is formed at an end portion extending in the width direction for being inserted into and engaged with a through-hole formed on a mounting substrate; and

a fixing member fixing the engaging member to the covering member,

wherein the insertion portion of the engaging member comprises an opening allowing an elastic deformation thereof upon the insertion into the through-hole and a protruding portion for preventing disengagement in a direction opposite to the insertion direction after being inserted into the through-hole.

In the above embodiment (1) of the invention, the following modifications and changes can be made.

(i) The engaging member comprises a metal and has a thickness more than the conductor.

(ii) A portion of the insertion portion of the engaging member on the fixing portion side of the protruding portion has a size of not more than a diameter of the through-hole in a direction orthogonal to the insertion direction.

(iii) The engaging member is arranged such that a longitudinal direction thereof crosses a longitudinal direction of the conductor.

(iv) The plurality of conductors each comprise a connection portion to be connected to a first electrode on the mounting substrate, and the engaging member comprises a connection portion to be connected to a second electrode on the mounting substrate.

(v) The engaging member has the opening with an open or closed tip portion and further comprises an inclined surface at least at a portion from the tip portion to an upper edge of the protruding portion.

(vi) The opening has such a shape that an opening width decreases toward the fixing member.

(2) According to another embodiment of the invention, a mounting body comprises: a flat wiring material comprising a plurality of conductors arranged in parallel at intervals in a width direction, an insulating covering member for covering collectively the plurality of conductors while allowing both end portions of the plurality of conductors to be exposed, an engaging member disposed at a position on the covering member and close to at least one of the exposed both end portions of the plurality of conductors and comprising an insertion portion that is formed at an end portion extending in the width direction for being inserted into and engaged with a through-hole formed on a mounting substrate, and a fixing member fixing the engaging member to the covering member, wherein the insertion portion of the engaging member comprises an opening allowing an elastic deformation thereof upon the insertion into the through-hole and a protruding portion for preventing disengagement in a direction opposite to the insertion direction after being inserted into the through-hole; and

a mounting substrate comprising the through-hole for inserting the insertion portion of the engaging member of the flat wiring material.

In the above embodiment (2) of the invention, the following modifications and changes can be made.

(vii) The engaging member of the flat wiring material comprises a metal and has a thickness more than the conductor.

(viii) The mounting substrate further comprises, on a surface for mounting a flat wiring material, first electrodes to be solder-connected to the plurality of conductors and a second electrode to be solder-connected to the engaging member,

wherein the plurality of conductors of the flat wiring material each comprise a first connection portion to be solder-connected to the first electrode of the mounting substrate,

wherein the engaging member comprises a second connection portion to be solder-connected to the second electrode of the mounting substrate, and

wherein the insertion portion of the engaging member has a shape allowing movement in the insertion direction of the flat wiring material when solder-connecting the first and second electrodes to the first and second connection portions.

(ix) The insertion portion of the engaging member is inserted into the through-hole of the mounting substrate and is then joined to the mounting substrate by a solder.

(x) The engaging member comprises a pair of engaging members that are provided on the covering member at positions respectively close to the exposed both end portions of the plurality of conductors, and

wherein the pair of engaging members are each engaged with a different mounting substrate.

### EFFECTS OF THE INVENTION

According to one embodiment of the invention, a flat wiring material can be provided that allows stable and highly reliable solder connection between an exposed portions of a conductor and an electrode portion of a mounting substrate even when the exposed portion of the conductor of the flat wiring material such as a flexible flat cable, an MFJ and a flexible printed circuit board is directly connected by a solder to the electrode portion of the mounting substrate pre-coated with the solder, as well as a mounting body using the flat wiring material.

### BRIEF DESCRIPTION OF THE DRAWINGS

Next, the present invention will be explained in more detail in conjunction with appended drawings, wherein:

FIGS. 1A and 1B show an appearance of a flexible flat cable in an embodiment of the present invention, wherein FIG. 1A is a plan view and FIG. 1B is a front view;

FIG. 2 is a plan view showing of the flexible flat cable shown in FIG. 1A in which an engaging member is unfolded;

FIG. 3 is a diagram illustrating an exposed portion of a signal conductor and an exposed portion of the engaging member;

FIG. 4 is a cross sectional view taken along line A-A of FIG. 1A, showing a layer structure of the flexible flat cable;

FIG. 5 is a plan view showing the engaging member in which a covering member is partially removed in order to show the shape of the engaging member;

FIG. 6A is an essential-portion cross-sectional view showing a terminal end portion of the flexible flat cable in the embodiment of the invention;

FIG. 6B is an essential-portion cross-sectional view showing a terminal end portion of the flexible flat cable in the embodiment of the invention;

FIG. 6C is an essential-portion cross-sectional view showing a terminal end portion of the flexible flat cable in the embodiment of the invention;

FIG. 6D is an essential-portion cross-sectional view showing a terminal end portion of the flexible flat cable in the embodiment of the invention;

FIG. 6E is an essential-portion cross-sectional view showing a terminal end portion of the flexible flat cable in the embodiment of the invention;

FIG. 6F is an essential-portion cross-sectional view showing a terminal end portion of the flexible flat cable in the embodiment of the invention;

FIG. 7 is an essential-portion cross-sectional view showing a method of joining the engaging member in a modification;

FIG. 8A is an explanatory diagram illustrating Modification 2 in which two printed circuit boards are connected by the flexible flat cable shown in FIG. 1A;

FIG. 8B is an explanatory diagram illustrating Modification 2 in which two printed circuit boards are connected by the flexible flat cable shown in FIG. 1A; and

FIGS. 9A to 9E are partial plan views showing exemplary shapes of an insertion portion of the engaging member in Modification 3.

### DETAILED DESCRIPTION OF THE PREFERRED EMBODIMENTS

A preferred embodiment of the invention, Examples and Comparative Examples will be described below in reference to the appended drawings. Although a flexible flat cable will be described here as a typical example of the flat wiring material, the invention is applicable to other flat wiring materials such as an MFJ and a flexible printed circuit board. Note that, components having substantially the same functions are denoted by the same reference numerals in each drawing and the overlapping description will be omitted.

### Summary of Embodiments

A flat wiring material in the present embodiment is provided with plural conductors arranged in parallel at intervals in a width direction, an insulating covering member for covering the plural conductors all together so that both end portions of the plural conductors are exposed, an engaging member provided on the covering member at a position close to at least one of the exposed both end portions of the plurality of conductors and having an insertion portion which is formed at an end portion extended in the width direction and is inserted into and engaged with a through-hole formed on a mounting substrate, and a fixing member for fixing the engaging member to the covering member, wherein the insertion portion of the engaging member has an opening allowing elastic deformation thereof at the time of insertion into the through-hole and a protruding portion for preventing falling-out in a direction opposite to an insertion direction after the insertion into the through-hole.

Meanwhile, a mounting body in the present embodiment is provided with the flat wiring material in the above-mentioned embodiment and a mounting substrate having the through-hole for inserting the insertion portion of the engaging member of the flat wiring material.

The “mounting substrate” is a substrate to be electrically connected to one or both terminal end portions of the present flexible flat cable, and is, e.g., a printed circuit board, etc. “Fixation” of the engaging member to the covering member includes adhesion using an adhesive, welding (fusion) by heating and cooling, and ultrasonic welding, etc. The “position close to the end portion” is not only a position where the engaging member is slightly apart from the end portion from which the conductor is exposed (e.g., a distance shorter than a width of the engaging member) and but also may be a portion partially overlapping.

The position of the engaging member with respect to the exposed portions of the plural conductors is determined by fixing the engaging member, using the fixing member, to the covering member which covers the plural conductors, which allows the engaging member to be used for positioning with respect to the mounting substrate.

### Embodiments

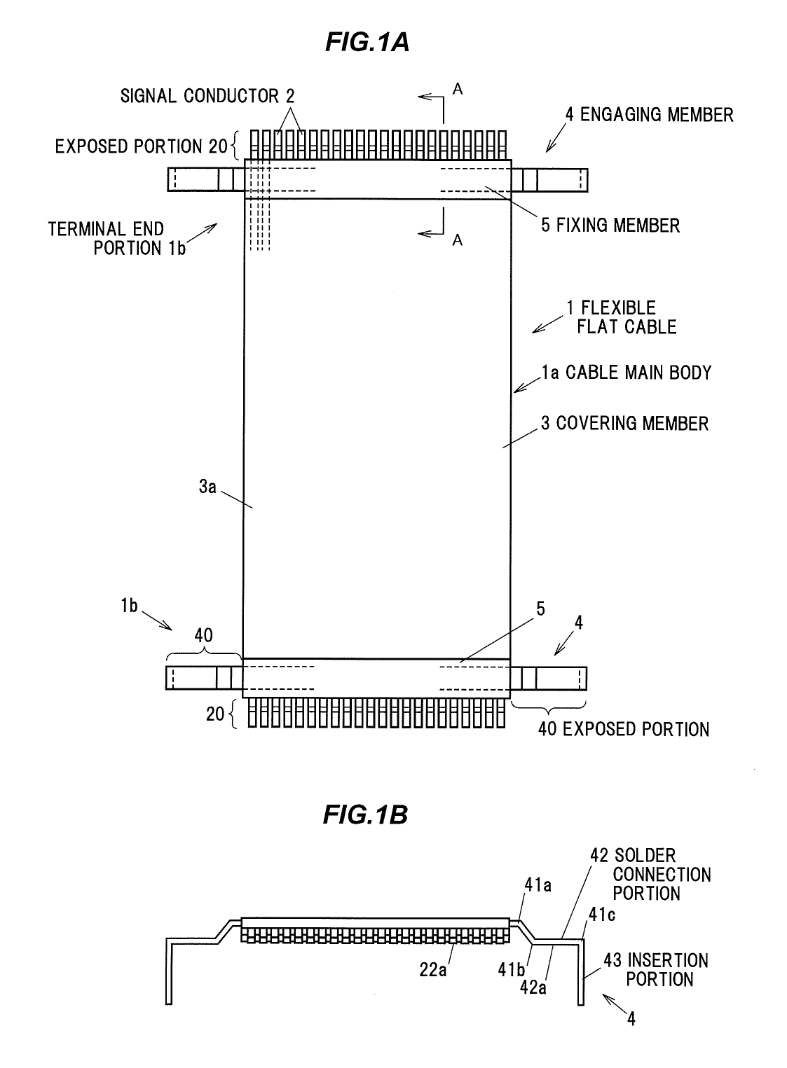

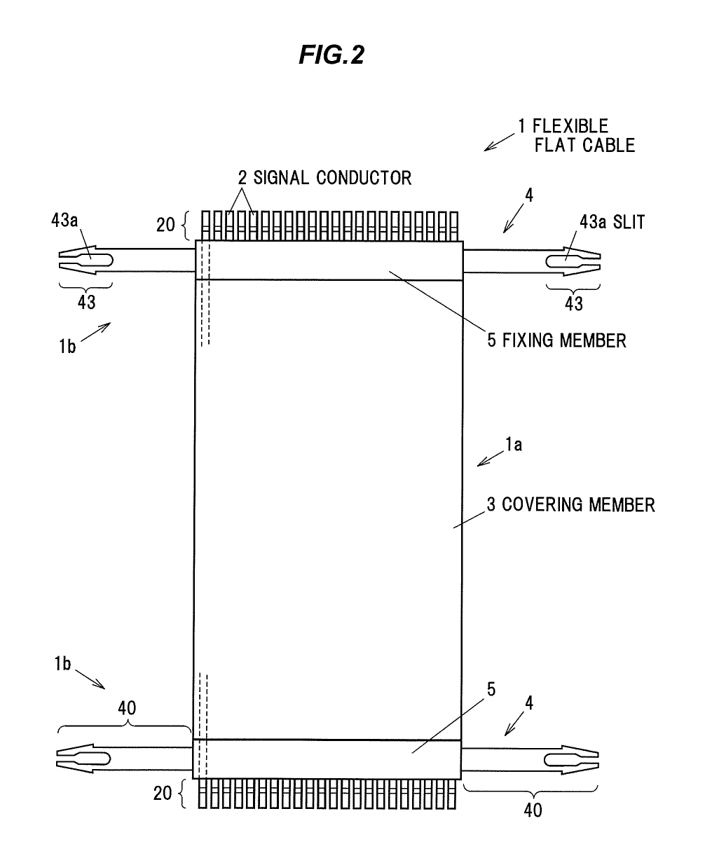

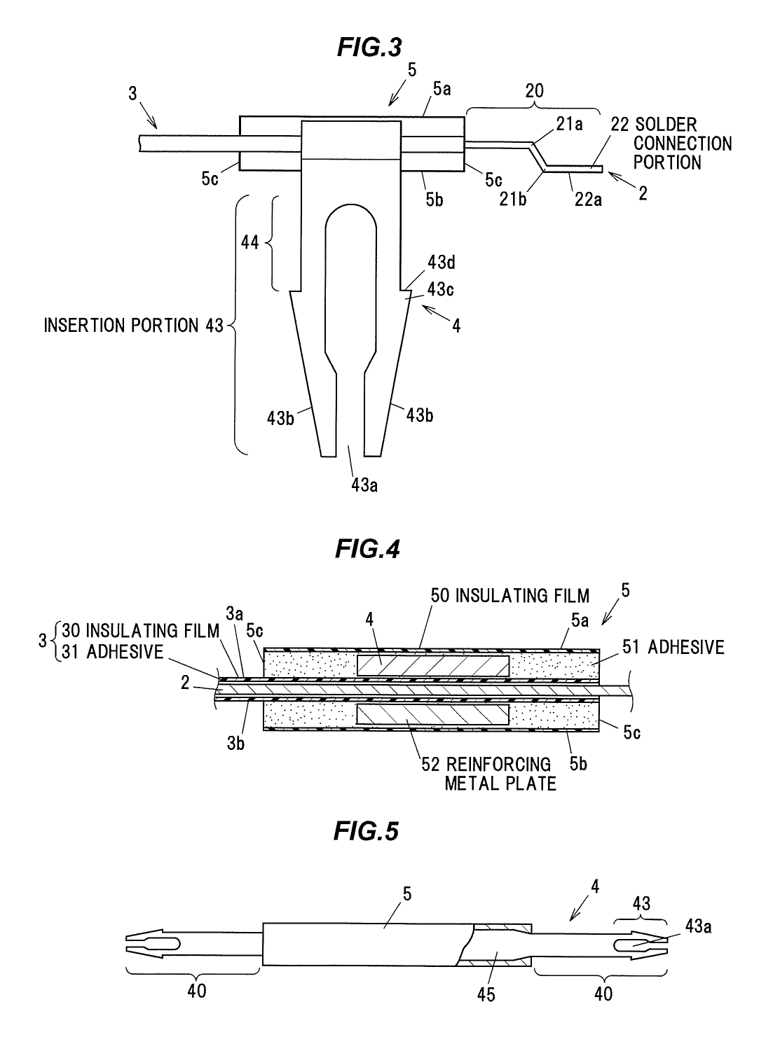

FIGS. 1A and 1B show an appearance of the flexible flat cable in the embodiment of the invention, wherein FIG. 1A is a plan view and FIG. 1B is a front view. FIG. 2 is a plan view showing of the flexible flat cable shown in FIG. 1A in which an engaging member is unfolded. FIG. 3 is a diagram illustrating an exposed portion of a signal conductor and an exposed portion of the engaging member.

As shown in FIGS. 1A and 1B, a flexible flat cable 1 is provided with a cable main body 1a including plural signal conductors 2 arranged in parallel at intervals in a width direction and an insulating covering member 3 for covering the plural signal conductors 2 all together so that both end portions of the signal conductors 2 are exposed, an engaging member 4 arranged so as to lie across the plural signal conductors 2 in a width direction and used for temporarily fixing the cable main body 1a to, e.g., a printed circuit board as the mounting substrate, and a fixing member 5 for fixing the engaging member 4 to the covering member 3 at both end portions (at a position close to exposed portions 20 of the signal conductors 2). It is possible to provide the engaging member 4 and the fixing member 5 at one or both ends of the cable main body 1a according to connection configuration of the cable main body 1a.

Herein, the vicinity of the fixing member 5 and the exposed portion 20 of the signal conductor 2 refers to a “terminal end portion” 1b of the cable main body 1a. The flexible flat cable 1 in the present embodiment has the terminal end portions 1b to be attached to the printed circuit board on both sides.

Signal Conductor

The signal conductor 2 has the exposed portions 20 which are exposed at both end portions from the covering member 3. The exposed portion 20 has an S-shape (gull-wing shape), as shown in FIG. 3, formed by bending at bent portions 21a and 21b so that a lower surface 22a of a solder connection portion 22 at the tip portion is substantially flush with a lower surface 5b of the fixing member 5. The lower surface 22a of the solder connection portion 22 is connected, by a solder, to a corresponding electrode portion formed on the printed circuit board. A preferred bending angle of the bent portions 21a and 21b is not more than 90 degrees. Surface tension of the solder which acts to reduce the surface area of the solder per se is caused by such an angle, which allows solder wicking to occur not only on the lower surface 22a of the solder connection portion 22 but also on the fixing member 5 side of the bent portion 21b. The increase in an amount of the solder wicking allows connection strength to be improved.

The signal conductor 2 may be formed of copper such as oxygen-free copper and tough pitch copper, or copper alloy. The surface of the copper or copper alloy may be plated with a metal such as tin (Sn), nickel (Ni) or gold (Au) alone or it may be used in a state that plural materials are laminated.

Covering Member

The covering member 3 may be formed of an insulation resin such as film-like polyimide resin or polyethylene terephthalate (PET) resin.

Engaging Member

As shown in FIG. 1B, the engaging member 4 has an S-shape (gull-wing shape) formed by bending at bent portions 41a and 41b so that a lower surface 42a of a solder connection portion 42 as an middle portion of an exposed portion 40 exposed from the fixing member 5 is substantially flush with the lower surface 22a of the solder connection portion 22 of the signal conductor 2. And the engaging member 4 also has a bent portion 41c which is bent 90 degrees so that an insertion portion 43 at the tip portion is orthogonal to the surface of the printed circuit board. The solder connection portion 42 of the engaging member 4 is connected, by a solder, to a corresponding electrode portion formed on the printed circuit board. A preferred bending angle of the bent portions 41a and 41b is not more than 90 degrees. Surface tension of the solder which acts to reduce the surface area of the solder per se is caused by such an angle, which allows solder wicking to occur not only on the lower surface 42a of the solder connection portion 42 but also on the fixing member 5 side of the bent portion 41b. The increase in an amount of the solder wicking allows connection strength to be improved.

As shown in FIGS. 2 and 3, a slit 43a allowing elastic deformation in a width direction is formed on the insertion portion 43 and constitutes an elastic deformation portion. In addition, inclined surfaces 43b are formed on the insertion portion 43 to facilitate insertion into a though-hole of the printed circuit board, and protruding portions 43c for preventing falling-out after inserting the insertion portion 43 into the though-hole of the printed circuit board are also formed. The slit 43a is an example of an opening for imparting a function as an elastic deformation portion to the insertion portion 43. Therefore, the opening is not limited to a slit and may be a circular hole or an elongated hole, etc.

The engaging member 4 is preferably formed of a material having higher strength (higher tensile strength) than the signal conductor 2 and it is possible to use, e.g., copper alloys such as phosphor bronze or iron (Fe)-nickel (Ni) alloy, etc. The exposed portion 40 of the engaging member 4 may be plated with the same material as that used for plating the exposed portion 20 of the signal conductor 2. In addition, it is preferable that the engaging member 4 be thicker than a metal material used for the signal conductor 2. A higher reinforcing effect against vibration load at a portion in the vicinity of the solder connection portion 22 of the signal conductor 2 is obtained by use of a high strength material and an increase in plate thickness. In addition, when the insertion portion 43 of the engaging member 4 is inserted into the through-hole of the printed circuit board, the elastic deformation portion having less rigidity deforms and the engaging member 4 is thereby inserted into the through-hole since the engaging member 4 is formed of the above-mentioned metal material and is thicker than the signal conductor 2. If the engaging member 4 is thin in such a case, out-of-plane deformation in a plate thickness direction of the engaging member 4 may occur due to pressure from the through-hole at the time of insertion. If the out-of-plane deformation occurs on the engaging member 4, the deformed portion comes into contact with an end portion or an inner surface of the through-hole and generates resistance, which impedes insertion of the engaging member 4. It is possible to suppress the out-of-plane deformation at the time of insertion into the through-hole of the printed circuit board by thickening the engaging member 4.

Layer Structure of the Flexible Flat Cable FIG. 4 is a cross sectional view taken along line A-A of FIG. 1A, showing a layer structure of the flexible flat cable. In the covering member 3, an insulating film 30 on the surface is adhered to the signal conductor 2 by an adhesive 31. The adhesive 31 used for adhering the signal conductor 2 to the insulating film 30 may be formed of, e.g., a thermosetting resin such as epoxy resin or acrylic resin.

The engaging member 4 is arranged on the covering member 3 on one surface 3a side, a reinforcing metal plate 52 is arranged on the covering member 3 on another surface 3b side, and then, the engaging member 4, the reinforcing metal plate 52 and an insulating film 50 covering both are fixed to the covering member 3 by an adhesive 51, and the fixing member 5 thereby functions as a reinforcing member which suppresses deformation of the portion in the vicinity of the solder connection portion 22 of the signal conductor 2.

The reinforcing metal plate 52 is preferably formed of a material having higher strength (higher tensile strength) than the signal conductor 2 in the same manner as the engaging member 4 and is formed of, e.g., phosphor bronze or iron (Fe)-nickel (Ni) alloy, etc. The reinforcing metal plate 52 may be formed of the same material as or a different material from the engaging member 4 as long as the material satisfies the above-mentioned conditions. It is preferable that the reinforcing metal plate 52 be thicker than a metal material used for the signal conductor 2. A higher reinforcing effect against vibration load at the portion in the vicinity of the solder connection portion 22 of the signal conductor 2 is obtained by use of a high strength material and an increase in plate thickness and also by using together with the engaging member 4.

The same material as the adhesive 31 adhering the insulating film 30 to the signal conductor 2 may be used for the adhesive 51 adhering the engaging member 4, the reinforcing metal plate 52 and the insulating film 50 to the covering member 3 covering the signal conductor 2.

FIG. 5 is a plan view showing the engaging member in which the covering member is partially removed in order to show the shape of the engaging member. It should be noted that FIG. 5 shows the engaging member before being bent. The engaging member 4 has a wide portion 45 which is wider than the exposed portion 40. This also provides an effect of reinforcing the portion in the vicinity of the solder connection portion 22 of the signal conductor 2.

Method of Manufacturing the Flexible Flat Cable

Next, an example of a method of manufacturing the flexible flat cable in the present embodiment will be described. Firstly, plural signal conductors 2 and a pair of engaging members 4 are prepared. Next, the insulating film 30 is adhered to the plural signal conductors 2 by using the adhesive 31, thereby forming the covering member 3.

Then, the engaging members 4 are arranged, on the one surface 3a side, at both end portions of the covering member 3 which covers the signal conductor 2, the reinforcing metal plates 52 are arranged on the other surface 3b side at both end portions of the covering member 3, and then, the engaging members 4, the reinforcing metal plates 52 and the insulating film 50 are adhered to the covering member 3 by using an adhesive 51.

Method of Mounting to Printed Circuit Board

Next, a method of mounting the flexible flat cable in the present embodiment to the printed circuit board will be described in reference to the drawings.

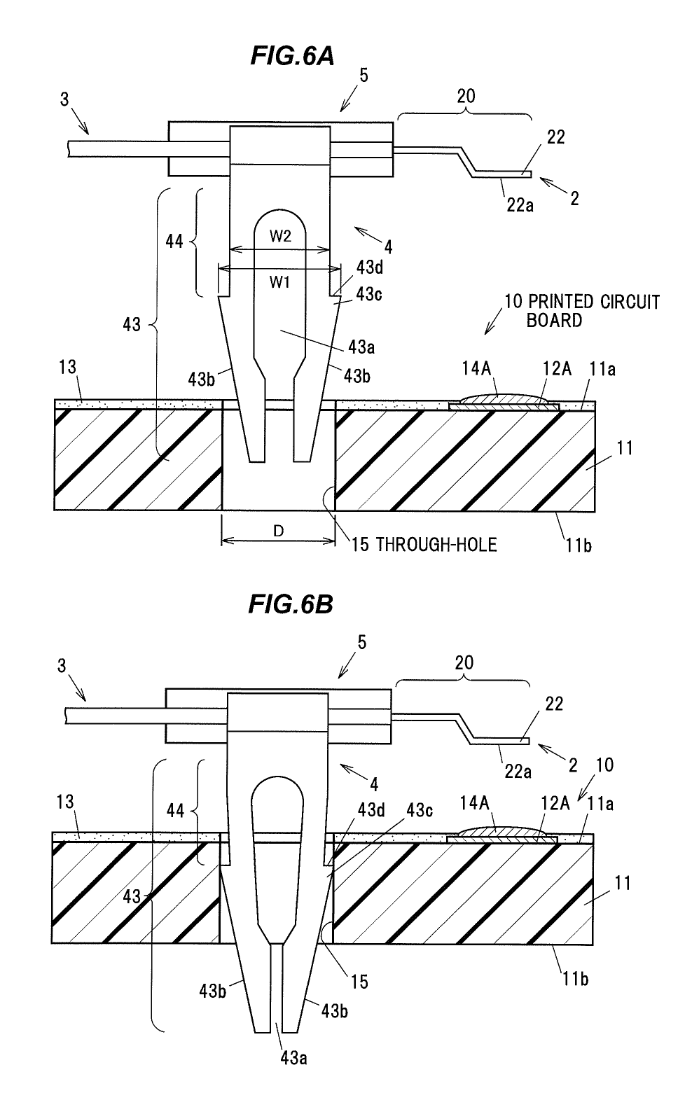

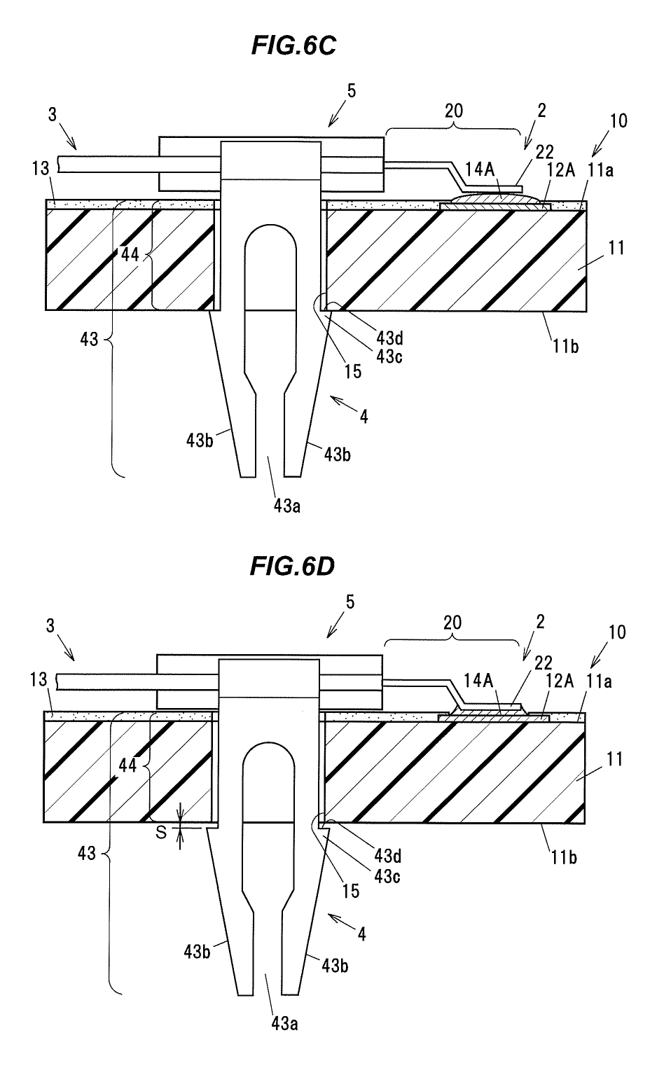

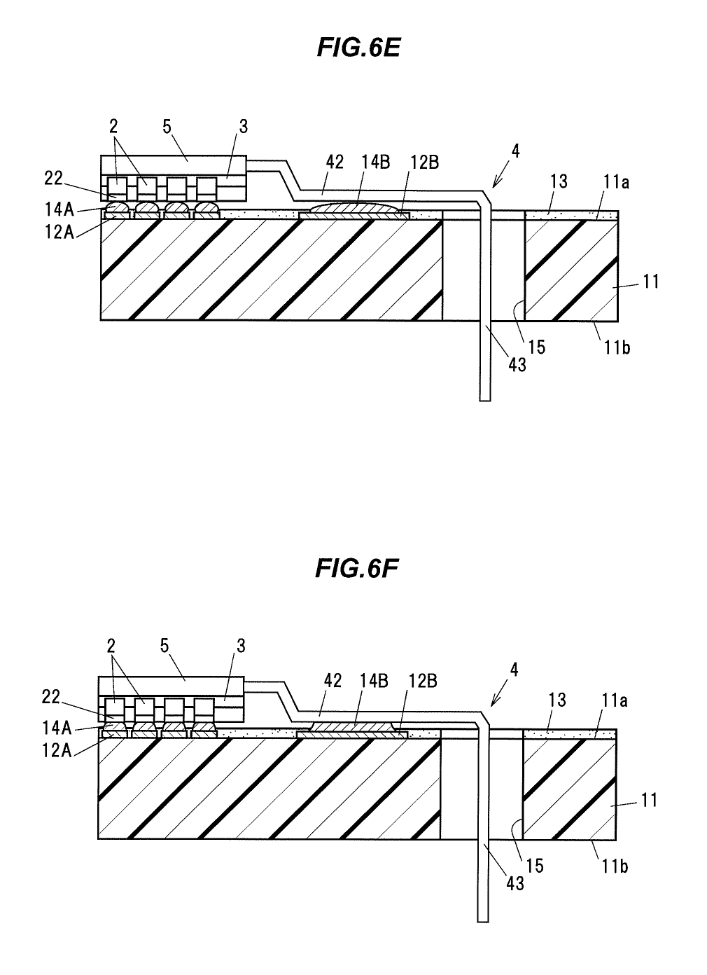

FIGS. 6A to 6F are essential-portion cross-sectional views showing a terminal end portion of the flexible flat cable in the embodiment of the invention.

As shown in FIG. 6A, a printed circuit board 10 for mounting the flexible flat cable 1 is provided with an insulating base material 11, an electrode portion 12A and a solder resist 13 which are formed on a surface 11a of the insulating base material 11, a solder 14A formed on the surface of the electrode portion 12A, and a through-hole 15 which penetrates the insulating base material 11.

The through-hole 15 of the printed circuit board 10 is in a state after a hole-making process using a drill or laser. After the hole-making process, an electrode portion may be formed on an inner surface of the through-hole 15 by plating nickel (Ni) or gold (Au).

As shown in FIG. 6A, the insertion portion 43 of the engaging member 4 is inserted into the through-hole 15 of the printed circuit board 10 from the surface 11a side of the printed circuit board 10. In a state that the insertion portion 43 is not yet inserted into the through-hole 15, a width W1 between upper edges 43d of the protruding portions 43c of the insertion portion 43 of the engaging member 4 is greater in size than a diameter D of the through-hole 15 (i.e., W1>D).

Meanwhile, a width W2 of an upper portion 44 of the insertion portion 43 above the protruding portions 43c is configured to have a size smaller than the diameter D of the through-hole 15 (i.e., W2<D). The size (the width W2 and thickness) of the upper portion 44 of the engaging member 4 in a direction orthogonal to the insertion direction, which is smaller than the diameter D of the through-hole 15, allows the solder connection portion 22 of the signal conductor 2 to be arranged on the electrode portion 12A of the printed circuit board 10 pre-coated with the solder 14A and allows the engaging member 4 to follow downward movement without receiving resistance from the through-hole 15 when the solder 14A is heated and melted.

When the engaging member 4 is further inserted into the through-hole 15 of the printed circuit board 10, the elastic deformation portion gradually deforms in a direction of narrowing the width thereof due to pressure from the inner surface of the through-hole 15. When further inserted, the upper edges 43d of the protruding portions 43c are also inserted inside the through-hole 15 as shown in FIG. 6B and moves in the insertion direction (downward in the drawing) while being in contact with the inner surface of the through-hole 15. At this time, the upper portion 44 above the upper edges 43d of the protruding portions 43c moves in the insertion direction without contact with the inner surface of the through-hole 15 since the width W2 of the upper portion 44 is not more than the diameter D of the through-hole 15.

When the engaging member 4 is further inserted, the upper edges 43d of the protruding portions 43c protrude from the through-hole 15, as shown in FIG. 6C. After protruding from the through-hole 15, the elastic deformation portion deforms outwardly, e.g., in a direction of expanding the width due to an elastic force and returns to the width W1 which is a width before the insertion into the through-hole 15. Since the maximum width W1 of the insertion portion 43 of the engaging member 4 is greater than the diameter D of the through-hole 15, the upper edges 43d of the protruding portions 43c come into contact with and are locked to a back surface of the printed circuit board 10, and it is thus possible to prevent the engaging member 4 from falling out in a direction opposite to the insertion direction when mechanical load generated due to vibration is applied.

Meanwhile, the insertion of the engaging member 4 into the through-hole 15 of the printed circuit board 10 aligns the positions of the solder connection portions 22 of the signal conductors 2 with the corresponding electrode portions 12A of the printed circuit board 10 which are to be connected to the solder connection portions 22. In other words, it is possible to temporarily fix the flexible flat cable 1 to the printed circuit board 10 in a state that the signal conductors 2 are respectively positioned on the corresponding electrode portions 12A of the printed circuit board 10 by the insertion portion 43 functioning as the elastic deformation portion provided on the engaging member 4 and the protruding portions 43c provided on the insertion portion 43. The electrode portion 12A is exposed from the solder resist 13 formed on the surface 11a of the printed circuit board 10 and is allowed to be electrically connected to the solder connection portion 22 of the signal conductor 2. Since the upper edges 43d of the protruding portions 43c of the engaging member 4 penetrates to and is locked to the back surface 11b of the printed circuit board 10, the solder connection portion 22 of the signal conductor 2 is fixed in a state of being arranged on the solder 14A which is preliminarily applied to the electrode portion 12A. The upper portion 44 above the upper edges 43d of the protruding portions 43c which is now located inside the through-hole 15 is held in a state of not being in contact with the inner surface of the through-hole 15 or in a state of not receiving excess pressure even if partially coming into contact therewith since the width W2 of the upper portion 44 is smaller than the diameter D of the through-hole 15.

The solder 14A is melted by heating the solder connection portion 22 of the signal conductor 2 of the flexible flat cable 1 which is held in the state shown in FIG. 6C, and the solder connection portion 22 of the signal conductor 2 is connected to the electrode portion 12A of the printed circuit board 10 by the solder 14A, as shown in FIG. 6D. When the solder 14A is melted, the solder connection portion 22 moves and sinks downward, i.e., in a direction toward the printed circuit board 10 in FIG. 6D, due to self-weight of the flexible flat cable 1 or, in case of solder connection using a heating tool, due to load applied from above the solder connection portion 22. Since the upper portion 44 above the upper edges 43d of the protruding portions 43c does not receive pressure from the inner surface of the through-hole 15 as described above, the engaging member 4 inserted into the through-hole 15 also moves downward since it is easy to follow the movement caused by the solder connection. In a state that the solder 14A is solidified and the solder connection portion 22 of the signal conductor 2 is connected to the electrode portion 12A, a gap S corresponding to the sinking movement of the solder connection portion 22 is generated between the upper edges 43d of the protruding portions 43c of the engaging member 4 and the back surface 11b of the printed circuit board 10.

Since the engaging member 4 moves by following the movement due to the sinking at the time of melting the solder and thus can sink without receiving external resistance, a wet spreading property of the solder on the solder connection portion 22 is improved, voids (holes) are eliminated and it is possible to obtain good solder connection with a solder fillet formed thereon.

As described above, the engaging member 4 is arranged at both end portions of the covering member 3 so as to lie across the plural signal conductors 2 in a width direction and the fixing member 5 of the engaging member 4 serves as a reinforcing member for suppressing deformation in the vicinity of an end portion 5c of the fixing member 5 or the solder connection portion 22 caused by mechanical load.

In order to further improve the deformation-suppressing effect by the engaging member 4, the solder connection portion 42 of the engaging member 4 is solder-connected to an electrode portion 12B of the printed circuit board 10 in the same manner as the signal conductor 2, as shown in FIGS. 6E and 6F. The flexible flat cable 1 provided with the engaging member 4 is arranged on the surface of the printed circuit board 10 by inserting the insertion portion 43 of the engaging member 4 into the through-hole 15 of the printed circuit board 10, as shown in FIG. 6E. Solders 14A and 14B are respectively preliminarily applied to the electrode portions 12A and 12B of the printed circuit board 10 which respectively correspond to the solder connection portions 22 of the signal conductors 2 and the solder connection portions 42 of the engaging member 4. By heating and melting the solder in this state, the solder connection portions 22 of the signal conductors 2 and the solder connection portions 42 of the engaging member 4 are respectively connected to the electrode portions 12A and 12B.

Note that, the solders 14A and 14B applied to the electrode portions 12A and 12B of the printed circuit board 10 are supplied as paste solder containing flux or solvent. Alternatively, the solder may be paste solder which has been applied to the electrode portions 12A and 12B of the printed circuit board 10 and is then heated, melted and solidified.

### Effects of the Embodiment

According to the present embodiment, in the flexible flat cable provided with the engaging member 4 and a mounting body using the same, even when the exposed portions 20 of the signal conductors 2 of the flexible flat cable are directly connected to the electrode portions 12A of the printed circuit board 10 pre-coated with a solder, it is possible to temporarily fix the exposed portions 20 of the signal conductors 2 in a state of being respectively positioned on the respectively corresponding electrode portions 12A of the printed circuit board 10 and to suppress failure at the time of solder connection by following the sinking movement of the exposed portions 20 of the signal conductors 2 after temporarily fixation and during the melting of the solder, and it is thus possible to realize solder connection which is stable and highly reliable against long-term vibration load or thermal load. In addition, it is possible to provide a robust flexible flat cable and a mounting structure of a flexible flat cable to a printed circuit board which prevents damage on the solder connection portion 22 of the signal conductor 2 caused by oscillatory deformation of the flexible flat cable 1 per se under mechanical load applied thereto and also suppresses the number of mounting processes of the flexible flat cable 1. In detail, the present embodiment achieves the following effects.

(a) As described above, the engaging member 4 is covered, together with the reinforcing metal plate 52, by the insulating film 50 and the adhesive 51 which are respectively formed of the same materials as the insulating film 30 and the adhesive 31 covering the signal conductors 2, which forms the same laminated structure as the cable main body 1a. By employing such a structure, it is possible to form the laminated structure composed of the engaging member 4 and the reinforcing metal plate 52 by the same manufacturing method as for the cable main body 1a.

(b) Furthermore, the cable main body 1a, the engaging member 4 and the reinforcing metal plate 52 laminated via the insulating films 30 and 50 and the adhesives 31 and 51 in a predetermined layout can be integrally manufactured by a laminating process. By such integral manufacturing, the engaging member 4 and the reinforcing metal plate 52 are firmly adhered and fixed to the cable main body 1a.

(c) By providing the engaging member 4 in a direction substantially orthogonal to the longitudinal direction of the signal conductor 2 in the vicinity of the end portion of the covering member 3 so as to lie across the signal conductors 2 in a width direction, it is possible to use the engaging member 4 as a member for reinforcing the vicinity of the solder connection portion 22 of the signal conductor 2.

(d) By reinforcing the vicinity of the solder connection portion 22, it is possible to reduce stress generated in the solder connection portion 22 and the signal conductor 2 in the vicinity thereof when mechanical load such as vibration is applied, and it is thus possible to suppress occurrence of fracture.

(e) It is possible to suppress deformation of the flexible flat cable 1 in the thickness direction in the vicinity of the solder connection portion 22 of the signal conductor 2 by a portion of the engaging member 4 (e.g., the wide portion 45) excluding the insertion portion 43 or by the reinforcing metal plate 52. As a result, it is possible to reduce stress generated in the solder connection portion 22 and the vicinity thereof when mechanical load such as vibration is applied to the solder connection portion 22 of the signal conductor 2. The stress-suppressing effect by the engaging member 4 can be further improved by an increase in rigidity resulting from making the engaging member 4 and the reinforcing metal plate 52 thicker than the signal conductor 2.

(f) Since the engaging member 4 is integrally formed with the cable main body 1a via the insulating film 30 and the adhesive 31, the engaging member 4 is firmly adhered to the cable main body 1a. This firm adhesion prevents separation from occurring at the adhered portion between the engaging member 4 and the cable main body 1a even when vibration load is applied to the flexible flat cable 1, and it is possible to stably maintain the above-mentioned stress-suppressing effect in the vicinity of the solder connection portion 22 of the signal conductor 2 by the engaging member 4.

(g) In addition, by using the flexible flat cable 1 in which the engaging member 4 and the signal conductors 2 are integrally formed in a well-controlled manufacturing process, it is possible to achieve high accuracy in the relative position of the solder connection portion 22 of the signal conductor 2 with respect to the insertion portion 43 of the engaging member 4 to be inserted into the through-hole 15 of the printed circuit board 10.

(h) Only by inserting the engaging member 4 manufactured with high accuracy into the through-hole 15 of the printed circuit board 10, it is possible to accurately and easily align the positions of the plural solder connection portions 22 of the signal conductors 2 with the corresponding solders 14A of the printed circuit board 10.

(i) In addition, the integration allows an increase in the number of components to be suppressed and mounting/assembly work to be simplified.

### Modification 1

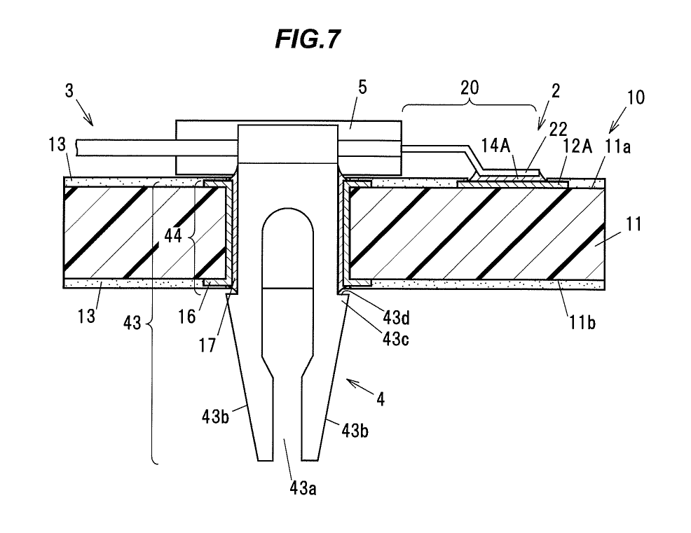

FIG. 7 is an essential-portion cross-sectional view showing a method of joining the engaging member in Modification 1. It may be configured that an electrode portion 16 formed of a metal material such as gold or nickel is formed on the inner surface of the through-hole 15 of the printed circuit board 10 and the insertion portion 43 of the engaging member 4 is inserted into the through-hole 15 and is joined thereto by a solder 17 which is an example of a bonding material. In detail, after inserting the insertion portion 43 of the engaging member 4 into the through-hole 15, paste solder is injected inside the through-hole 15 and is heated and melted to join therebetween. This makes the engaging member 4 serve as a reinforcing member, and it is possible to further improve the effect of reinforcing the solder connection portion 22 of the signal conductor 2 and to enhance the stress-reducing effect by the engaging member 4.

The insertion portion 43 of the engaging member 4 may be joined to the electrode portion 16 of the through-hole 15 at the same time as joining the solder connection portion 22 of the signal conductor 2 to the electrode portion 12A, or alternatively, after connection to the solder connection portion 22 of the signal conductor 2. In addition, the insertion portion 43 of the engaging member 4 may be joined to the through-hole 15 by an adhesive consisting mainly of a resin material such as epoxy, acrylic or polyimide instead of joining by a metal material such as solder. Furthermore, a portion of the engaging member 4 other than the insertion portion 43 may be joined, by a solder material, to a connecting electrode formed on the printed circuit board 10. By employing such a structure, the solder connection portion 22 of the signal conductor 2 is more firmly restrained by the printed circuit board 10 via the engaging member 4. Restraint by the printed circuit board 10 allows stress in the vicinity of the solder connection portion 22 to be reduced and occurrence of fracture of the signal conductor 2, etc., to be suppressed.

### Modification 2

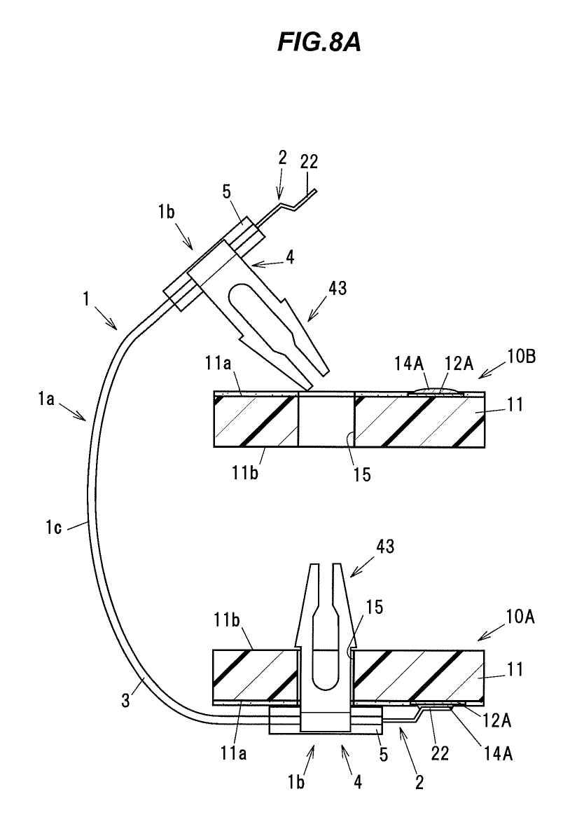

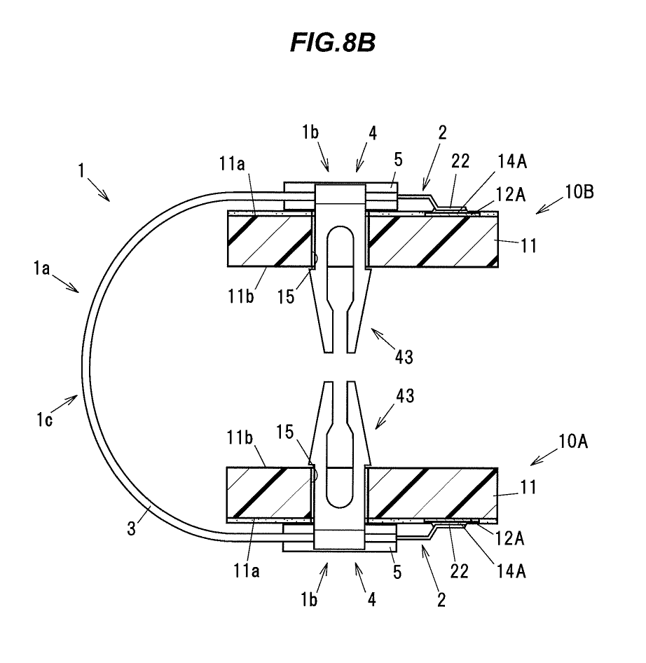

FIG. 6D or 6F shows an example in which the flexible flat cable 1 provided with the engaging member 4 is attached to the printed circuit board 10 at one terminal end portion 1b. In the case of connecting at least two stacked printed circuit boards by a flexible flat cable, both terminal end portions 1b are attached to the respective printed circuit boards. The connection state in such a case is shown in FIGS. 8A and 8B.

One terminal end portion 1b of the flexible flat cable 1 provided with the engaging member 4 is attached to a first printed circuit board 10A (a lower printed circuit board in the drawings) by the method shown in FIGS. 6A to 6D. First and second printed circuit boards 10A and 10B are vertically arranged in a stacked manner (the first printed circuit board 10A is positioned on the lower side in FIG. 8A) and the flexible flat cable 1 is bent at a center portion 1c so as to allow the insertion portion 43 of the engaging member 4 to be inserted into the through-hole 15 from the surface side of the upper second printed circuit board 10B. Likewise, the other terminal end portion 1b of the flexible flat cable 1 is attached to the second printed circuit board 10B as shown in FIG. 8B by the method shown in FIGS. 6A to 6D, and the stacked printed circuit boards 10A and 10B are thereby connected by the flexible flat cable 1.

When mechanical vibration is applied to a device mounting a printed circuit board-mounting product in which the stacked first and second printed circuit boards 10A and 10B are connected by the flexible flat cable 1 as shown in FIG. 8B, large oscillatory deformation due to a resonance phenomenon may occur in the flexible flat cable 1 per se which connects the printed circuit boards. Especially when oscillatory deformation in a thickness direction of the printed circuit board 10B (vertical direction in FIG. 8B) occurs in the flexible flat cable 1, the oscillatory deformation intensively acts on the vicinity of the solder connection portion 22 as a fixed end of the signal conductor 2 and generates high stress at the end portion of the solder connection portion 22 on the solder 14A or the exposed portion 20 of the signal conductor 2 in the vicinity of an end portion 5c of the fixing member 5.

In the flexible flat cable 1 provided with the engaging member 4 according to the invention, the engaging member 4 and the reinforcing metal plate 52 which are formed of a metal plate are arranged in the vicinity of the end portion of the covering member 3 of the flexible flat cable 1. These members serve as a reinforcing member which suppresses deformation, caused by mechanical load, of the signal conductor 2 in the vicinities of the solder connection portion 22 and the end portion of the covering member 3, and it is possible to disperse high stress concentration by suppressing the oscillatory deformation.

Furthermore, in the present embodiment, the solder connection portion 42 provided on the exposed portion 40 of the engaging member 4 is solder-connected to the electrode portion 12B of the printed circuit board 10A or 10B in the same manner as the signal conductor 2, as shown in FIGS. 6E and 6F. The connection to the printed circuit boards 10A and 10B makes the flexible flat cable 1 firmly fixed to the printed circuit boards 10A and 10B via the engaging member 4. The above-mentioned oscillatory deformation which occurs in the terminal end portion 1b of the flexible flat cable 1 is significantly reduced due to restraint by the printed circuit boards 10A and 10B, and initiation stress is also reduced. These allow a flexible flat cable with improved resistance against vibration load to be provided.

### Modification 3

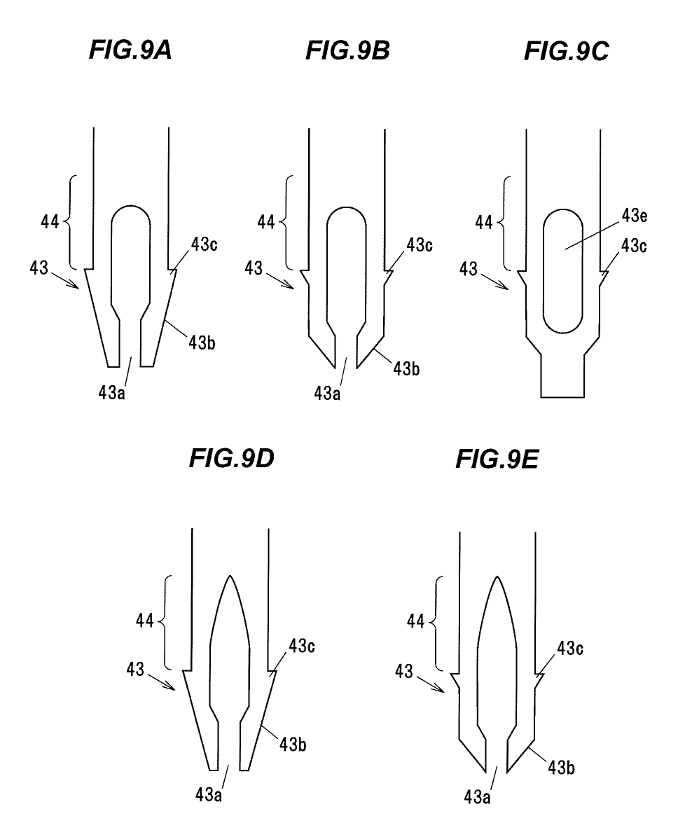

As for the elastic deformation portion provided on the insertion portion 43 of the engaging member 4 in the embodiment, the slit 43a for imparting an elastic deformation function and the protruding portion 43c may have the shapes as shown in FIGS. 9A to 9E in addition to the shape shown in FIG. 3, etc.

FIG. 9A is the insertion portion 43 shown in FIG. 3, etc., which functions as an elastic deformation portion and in which the slit 43a is continuously formed to the tip portion. The slit 43a has an elongated hole shape from the middle portion to the upper end portion. The inclined surface 43b from the tip portion of the insertion portion 43 to the upper portion of the protruding portion 43c is formed in a continuous tapered shape.

The insertion portion 43 in FIG. 9B has substantially the same structure as that in FIG. 9A but the inclined surface 43b of the tapered portion of the protruding portion 43c is short.

The insertion portion 43 in FIG. 9C has a structure in which the tip portion of FIG. 9B is closed, and a closed elongated hole 43e is formed instead of the slit 43a. When using the engaging member 4 in which the tip portion of the opening is open as shown in FIGS. 9A and 9B, a tip of the terminal may come into contact with other members or jig and tool during a mounting process or handling, resulting in deformation. Therefore, it is necessary to use a highly-rigid metal material for the engaging member 4 and to provide an adequate plate thickness. By employing the structure in which the tip of the opening is closed as shown in FIG. 9C, it is possible to suppress the above-mentioned deformation of the tip portion of the insertion portion 43.

The shape of the insertion portion 43 in FIG. 9D is substantially the same as that in FIG. 9A but the slit 43a is different since a width of the opening is narrowed toward the upper side.

Meanwhile, the insertion portion 43 in FIG. 9E has substantially the same structure as that in FIG. 9B but the shape of the slit 43a is the same as that of FIG. 9D. By forming the opening to have the shapes as shown in FIGS. 9D and 9E, it is possible to increase rigidity of the insertion portion 43 of the engaging member 4 at the upper portion 44 above the protruding portions 43c. This provides an effect of suppressing occurrence of out-of-plane deformation (in a plate thickness direction of the insertion portion of the engaging member) of the insertion portion 43 at the upper edge of the through-hole 15 caused by resistance from the through-hole 15 when the insertion portion 43 is inserted into the through-hole 15 of the printed circuit board 10.

It should be noted that the invention is not intended to be limited to the embodiment and the examples, and the various kinds of modifications can be implemented without departing from the gist of the invention.

What is claimed is:

1. A flat wiring material, comprising:
a plurality of conductors arranged in parallel at intervals in a width direction;
an insulating covering member covering collectively the plurality of conductors while allowing both end portions of the plurality of conductors to be exposed;
an engaging member disposed at a position on the covering member and close to at least one of the exposed both end portions of the plurality of conductors and comprising an insertion portion that is formed at an end portion extending in the width direction for being inserted into and engaged with a through-hole formed on a mounting substrate; and
a fixing member fixing the engaging member to the covering member,
wherein the insertion portion of the engaging member comprises an opening allowing an elastic deformation thereof upon the insertion into the through-hole and a protruding portion for preventing disengagement in a direction opposite to the insertion direction after being inserted into the through-hole.

2. The flat wiring material according to claim 1, wherein the engaging member comprises a metal and has a thickness more than the conductor.

3. The flat wiring material according to claim 1, wherein a portion of the insertion portion of the engaging member on the fixing portion side of the protruding portion has a size of not more than a diameter of the through-hole in a direction orthogonal to the insertion direction.

4. The flat wiring material according to claim 1, wherein the engaging member is arranged such that a longitudinal direction thereof crosses a longitudinal direction of the conductor.

5. The flat wiring material according to claim 1, wherein the plurality of conductors each comprise a connection portion to be connected to a first electrode on the mounting substrate, and the engaging member comprises a connection portion to be connected to a second electrode on the mounting substrate.

6. The flat wiring material according to claim 1, wherein the engaging member has the opening with an open or closed tip portion and further comprises an inclined surface at least at a portion from the tip portion to an upper edge of the protruding portion.

7. The flat wiring material according to claim 6, wherein the opening has such a shape that an opening width decreases toward the fixing member.

8. A mounting body, comprising:
a flat wiring material comprising a plurality of conductors arranged in parallel at intervals in a width direction, an insulating covering member for covering collectively the plurality of conductors while allowing both end portions of the plurality of conductors to be exposed, an engaging member disposed at a position on the covering member and close to at least one of the exposed both end portions of the plurality of conductors and comprising an insertion portion that is formed at an end portion extending in the width direction for being inserted into and engaged with a through-hole formed on a mounting substrate, and a fixing member fixing the engaging member to the covering member, wherein the insertion portion of the engaging member comprises an opening allowing an elastic deformation thereof upon the insertion into the through-hole and a protruding portion for preventing disengagement in a direction opposite to the insertion direction after being inserted into the through-hole; and
a mounting substrate comprising the through-hole for inserting the insertion portion of the engaging member of the flat wiring material.

9. The mounting body according to claim 8, wherein the engaging member of the flat wiring material comprises a metal and has a thickness more than the conductor.

10. The mounting body according to claim 8, wherein the mounting substrate further comprises, on a surface for mounting a flat wiring material, first electrodes to be solder-connected to the plurality of conductors and a second electrode to be solder-connected to the engaging member,
wherein the plurality of conductors of the flat wiring material each comprise a first connection portion to be solder-connected to the first electrode of the mounting substrate,
wherein the engaging member comprises a second connection portion to be solder-connected to the second electrode of the mounting substrate, and
wherein the insertion portion of the engaging member has a shape allowing movement in the insertion direction of the flat wiring material when solder-connecting the first and second electrodes to the first and second connection portions.

11. The mounting body according to claim 8, wherein the insertion portion of the engaging member is inserted into the through-hole of the mounting substrate and is then joined to the mounting substrate by a solder.

12. The mounting body according to claim 8, wherein the engaging member comprises a pair of engaging members that are provided on the covering member at positions respectively close to the exposed both end portions of the plurality of conductors, and
wherein the engaging members are each engaged with a different mounting substrate.
